(19) United States
(12) Patent Application Publication
(10) Pub. No.: US 2024/0070092 A1
(43) Pub. Date: Feb. 29, 2024

(54) INPUT/OUTPUT EXPANSION EMULATION WITH A PROGRAMMABLE DEVICE

(71) Applicant: HEWLETT PACKARD ENTERPRISE DEVELOPMENT LP, Houston, TX (US)

(72) Inventors: Binh Q. Nguyen, Houston, TX (US); David F. Heinrich, Tomball, TX (US); Paul Anthony Kaler, Houston, TX (US)

(21) Appl. No.: 17/822,702

(22) Filed: Aug. 26, 2022

(51) Int. Cl. G06F 13/10; G06F 13/42

(52) U.S. Cl. CPC G06F 13/105; G06F 13/4221; G06F 2213/0026

(57) ABSTRACT

In some examples, a system includes a processor, a management controller; and a programmable device to provide input/output (I/O) expansion emulation to support communication with a plurality of I/O devices of a subsystem coupled to the system, where the programmable device provides a plurality of virtual registers as part of the I/O expansion emulation, the virtual registers associated with respective I/O devices of the plurality of I/O devices. The processor writes a value to a first virtual register of the plurality of virtual registers to trigger an output event relating to a first I/O device of the plurality of I/O devices at the subsystem. The management controller reads the first virtual register and, in response to the value written to the first virtual register, interact with the subsystem to issue the output event relating to the first I/O device at the subsystem.

### BACKGROUND

A computing system can employ various types of input/output (I/O) devices to perform various functions. Examples of I/O devices include storage devices, memory devices, network communication devices, and so forth. The computing system may include a system circuit board on which are mounted various electronic components, such as a processor, an I/O controller, and so forth. In some cases, I/O devices can be mounted on the system circuit board. Additionally, further I/O devices may be mounted on a separate circuit board that can be connected to the system circuit board to allow access of the I/O devices on the separate circuit board by electronic components on the system circuit board.

### BRIEF DESCRIPTION OF THE DRAWINGS

Some implementations of the present disclosure are described with respect to the following figures.

FIG. 1 is a block diagram of an arrangement that includes a computing system and an input/output (I/O) device subsystem, according to some examples.

FIG. 2 is a flow diagram of a process performed by various components, according to some examples.

FIG. 3 is a block diagram of a system according to some examples.

FIG. 4 is a block diagram of a management controller according to some examples.

FIG. 5 is a flow diagram of a process according to some examples.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

An input/output (I/O) device subsystem can include a collection of I/O devices. As used here, a “collection” of items can refer to a single item or multiple items. Thus, a collection of I/O devices can refer to a single I/O device or multiple I/O devices.

Examples of I/O devices can include storage devices (e.g., a disk-based storage devices, solid state drives, etc.), memory devices (e.g., dynamic random access memory (DRAM) devices, static random access memory (SRAM) devices, flash memory devices, etc.), network communication devices (e.g., network interface controllers, wireless communication devices, etc.), or other types of I/O devices. Generally, an “I/O device” refers to an electronic component that is configured to perform a specific function, such as in response to a request from another entity (e.g., a machine, a program, a user, etc.).

The I/O device subsystem can be connected over a computer bus to a computing system. Examples of computing systems include any or some combination of the following: a server computer, a desktop computer, a notebook computer, tablet computer, a smartphone, a game appliance, a vehicle, a household appliance, an Internet of Things (IoT) device, etc., or any portion of any of the foregoing.

A “computer bus” can refer to a communication link over which electronic components can communicate with one another. Signals exchanged over the computer bus can be defined by a standard, an open-source specification, a proprietary protocol, and so forth.

The I/O device subsystem can include features that can controlled by a computing system that is connected to the I/O device subsystem. As an example, a feature of the I/O device subsystem can include a visual indicator, which can be in the form of a collection of light emitting diodes (LEDs) or other types of light emitters. As another example, a visual indicator can include a display device. The computing system can control activation or deactivation of a visual indicator in the I/O device subsystem. Other example features of an I/O subsystem device subsystem can include a collection of sound devices (e.g., speakers, buzzers, etc.), a collection of vibration devices, and so forth.

Additionally, events may occur in the I/O device subsystem that are to be communicated to the computing system. An example of an event in the I/O device subsystem is a hot plug event. A hot plug event can refer to an event triggered by either an insertion (“hot insertion”) or a removal (“hot removal”) of an I/O device with respect to the I/O device subsystem while the I/O device subsystem remains powered and operational. For example, the I/O device subsystem can include an I/O slot into which an I/O device can be hot inserted or from which an I/O device can be hot removed. In response to a hot plug of an I/O device, the I/O device subsystem can issue event information that is sent to the computing system to notify the computing system of the hot plug event. The computing system can then take action in response to the hot plug event.

Other examples of events that can occur in an I/O device subsystem can include any or some combination of the following: a data error event (e.g., triggered by occurrence of a data error in the I/O device subsystem), a fault event (e.g., triggered by a fault in a program or hardware of the I/O device subsystem), a tamper event (e.g., triggered by a detection of tampering with the I/O subsystem by an outside entity), a motion event (e.g., triggered by detected movement of the I/O device subsystem by a motion sensor), an environmental condition event (e.g., an excessive temperature event detected by a temperature sensor, etc.), and so forth.

Generally, an “output event” can refer to an event provided by a computing system to an I/O device subsystem to control a collection of features of the I/O device subsystem, such as to activate or deactivate a collection of visual indicators, or to control any other type of feature of the I/O device subsystem.

An “input event” can refer to an event provided by the I/O device subsystem to the computing system, to notify the computing of an occurrence of an activity, an issue, etc., at the I/O device subsystem.

In some examples, a computing system can include a set of I/O expanders to allow a management controller in the computing system to communicate input or output events with an I/O device subsystem. An “I/O expander” can refer to circuitry that routes I/O signals between electronic components. The I/O signals provided by an I/O expander are in addition to those that are available over other computer buses of a computing system. In more specific examples, an I/O expander can include a general-purpose I/O (GPIO) expander, which allows for flexible and configurable use of I/O signals for various purposes.

In examples where the I/O device subsystem includes a relatively large quantity of I/O devices (or a large quantity of features associated with I/O devices), a correspondingly large quantity of I/O expanders, such as GPIO expanders, may have to be provided in a computing system to allow for communication of input and output events between the I/O device subsystem and the computing system. In some cases, hardware multiplexers may also have to be employed with the large quantity of I/O expanders to selectively route I/O signals between the management controller of the computing system and circuitry that controls features of the I/O device subsystem.

The presence of I/O expanders and multiplexers in the computing system can add complexity and cost to the computing system, and may also raise reliability issues due to the presence of the extra hardware circuitry.

Additionally, in some cases, an interface between a management controller in a computing system and circuitry of an I/O device subsystem may be a proprietary interface, which can add complexity since computing systems and/or I/O device subsystems from different vendors may have different proprietary interfaces.

In accordance with some implementations of the present disclosure, a programmable device can be included in a computing system to perform I/O expansion emulation to emulate I/O expanders to allow output events and input events relating to an I/O device subsystem to be communicated by electronic components of the computing system. The I/O expansion emulation provides a mechanism by which information of the output events and the input events can be exchanged. By emulating the I/O expanders, actual I/O expanders (and multiplexers associated with I/O expanders) would not have to be provided for the purpose of exchanging information of output events and input events relating to the 10 device subsystem.

In some examples, the I/O expansion emulation performed by the programmable device includes a provision of virtual registers useable for management of communications between a central processing unit (CPU) of the computing system and an I/O device subsystem that includes I/O devices. The virtual registers can correspond to respective I/O devices of the I/O device subsystem. A CPU can write a value to a first portion (e.g., a bit or multiple bits) of a virtual register to trigger an output event for an I/O device of the I/O device subsystem. The value written to the first portion of the virtual register is detected by a management controller in the computing system, and the value is used by the management controller to interact with a subsystem controller in the I/O device subsystem to control a feature corresponding to the first I/O device in the I/O device subsystem.

Additionally, the management controller can detect an input event (e.g., a hot plug event) relating to the I/O device at the I/O device subsystem, and the management controller can write a value to another portion (e.g., another bit or bits) in the virtual register to indicate an occurrence of the input event. The CPU detects occurrence of the input event based on the value written to the other portion of the virtual register, and the CPU can take action to handle the input event.

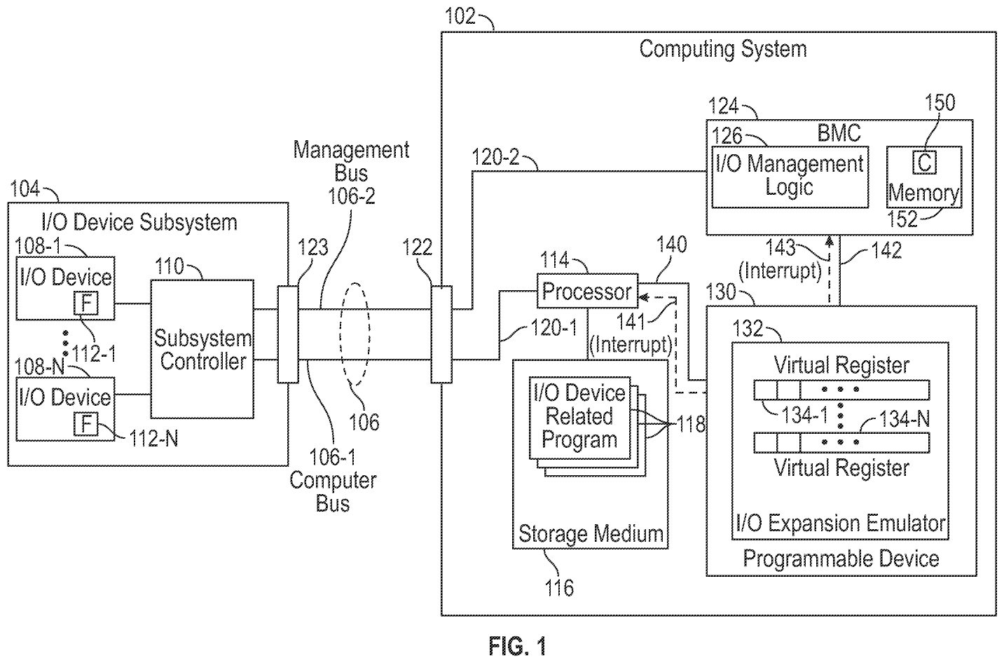

FIG. 1 is a block diagram of an example arrangement that includes a computing system 102 that is coupled to an I/O device subsystem 104 over communication links 106. In some examples, the computing system 102 can include a system circuit board on which are mounted various electronic components. The I/O device subsystem 104 can include a separate I/O device circuit board that can be coupled to the system circuit board of the computing system 102.

A “circuit board” can refer to an arrangement of layers, including electrically conductive layers and insulating layers between electrically conductive layers. Each electrically conductive layer can include electrically conductive traces to route signals between electronic components mounted on the circuit board or embedded within the circuit board.

In some examples, the I/O device circuit board can be a backplane board that can be connected to the system circuit board. A “backplane board” can include a collection of slots into which I/O devices (which can be in the form of electronic chips or circuit boards) can be electrically connected. The I/O devices can be fixedly connected to the slots of the backplane board, or alternatively, the I/O devices can be removably connected to the slots of the backplane board.

Although reference is made to a “backplane board” in some examples, it is noted that in other examples, the I/O device subsystem 104 can include a different type of circuit board, such as a midplane board, a daughter board, and so forth.

In other examples, the computing system 102 and the I/O device subsystem 104 can have different forms, such as in the form of modules with housings, and so forth.

The I/O device subsystem 104 includes I/O devices 108-1 to 108-N(N≥1). The I/O device subsystem 104 further includes a subsystem controller 110 that is connected to the I/O devices 108-1 to 108-N.

As used here, a “controller” can refer to one or more hardware processing circuits, which can include any or some combination of a microprocessor, a core of a multi-core microprocessor, a microcontroller, a programmable integrated circuit, a programmable gate array, or another hardware processing circuit. Alternatively, a “controller” can refer to a combination of one or more hardware processing circuits and machine-readable instructions (software and/or firmware) executable on the one or more hardware processing circuits.

The subsystem controller 110 can interact with the I/O devices 108-1 to 108-N to perform various tasks. For example, the subsystem controller 110 can activate or deactivate (or otherwise control) respective features 112-1 to 112-N related to the I/O devices 108-1 to 108-N, respectively. A feature is “related” to an I/O device if the feature provides an indication for the I/O device, interacts with the I/O device, or otherwise has any association with the I/O device. Each I/O device 108-i (i=1 to N) can be associated with a single feature or with multiple features. Conversely, each feature 112-i can relate to a single I/O device or to multiple I/O devices.

The features 112-1 to 112-N can include respective visual indicators (e.g., LEDs) in some examples, that can be activated or deactivated to provide indications for respective I/O devices. In other examples, the features 112-1 to 112-N can include other types of features.

The subsystem controller 110 can control a feature (or multiple features) in response to control information from the computing system 102, for example. For example, the computing system 102 can provide an output event to the I/O device subsystem 104 to cause the subsystem controller 110 to control a collection of features (a single feature or multiple features).

FIG. 1 shows the features 112-1 to 112-N as being part of the respective I/O devices 108-1 to 108-N. In other examples, the features 112-1 to 112-N can be external of the I/O devices that 108-1 to 108-N.

The subsystem controller 110 can also detect input events associated with the I/O devices 108-1 to 108-N. An example of such an input event is a hot plug event of an I/O device 108-i. In response to a hot plug (hot insertion or removal) of an I/O device 108-i, the subsystem controller 110 can generate event information that is sent to the computing system 102.

The communication links 106 between the computing system 102 and the I/O device subsystem 104 can include a computer bus 106-1 and a management bus 106-2 (which may also be referred to as a sideband bus).

The computing system 102 and the I/O device subsystem 104 communicates data and control information over the computer bus 106-1 to perform main target tasks of the I/O devices 108-1 to 108-N. For example, if the I/O devices 108-1 to 108-N are storage devices or memory devices, then the computing system 102 can perform an access of the storage or memory devices over the computer bus 106-1. An access can include sending a read request over the computer bus 106-1 from the computing system 102 to the I/O device subsystem 104. In response to the request, the I/O device subsystem 104 retrieves data from one or more storage or memory devices, and returns the read data over the computer bus 106-1 to the computing system 102. A request can alternatively include a write request sent from the computing system 102 over the computer bus 106-1 to the I/O device subsystem 104. The write request causes write data provided over the computer bus 106-1 from the computing system 102 to be written into one or more storage or memory devices in the I/O device subsystem 104.

In the foregoing example, the “main target tasks” of the I/O devices 108-1 to 108-N that include storage or memory devices are data access tasks.

In other examples, different types of I/O devices can perform other tasks based on interaction between the computing system 102 and the I/O device subsystem 104 over the computer bus 106-1.

Examples of the computer bus 106-1 can include any or some combination of the following: a Peripheral Component Interconnect Express (PCIe) bus, a Universal Serial Bus (USB), an InfiniBand bus, or any other type of computer bus.

The management bus 106-2 (which can also be referred to as a “management bus”) is used by the computing system 102 and the I/O device subsystem 104 to perform management tasks relating to the I/O device subsystem 104 that are separate from the main target tasks of the I/O devices 108-1 to 108-N of the I/O device subsystem 104. Examples of the management bus 106-2 can include any or some combination of the following: an I²C bus, an I³C bus, a System Management Bus (SMBus), and so forth.

The computing system 102 includes a processor 114 (or multiple processors). A processor can include a microprocessor, a core of a multi-core microprocessor, a microcontroller, a programmable integrated circuit, a programmable gate array, or another hardware processing circuit.

The processor (s) 114 can be considered the central processing unit (CPU) of the computing system 102 that executes various machine-readable instructions of the computing system 102. For example, the processor(s) 114 can execute an operating system (OS), firmware (e.g., such as Basic Input/Output System or BIOS code), an application program, a utility program, and so forth, of the computing system 102.

The computing system 102 includes a storage medium 116, which can be implemented with a collection of storage devices (a single storage device or multiple storage devices). Examples of storage devices include any or some combination of the following: disk-based storage devices, solid state drives, memory devices, and so forth. The storage medium 116 stores I/O device related programs 118 that when executed perform tasks relating to the I/O devices 108-1 to 108-N of the I/O device subsystem 104.

The I/O device related programs 118 are examples of utility programs executable in the computing system 102. The I/O device related programs 118 are executable by the processor(s) 114. Although FIG. 1 shows multiple I/O device related programs 118, in other examples, the computing system 102 can include just one I/O device related program 118.

As an example, an I/O device related program 118 can control activation or deactivation of a visual indicator (e.g., LED) of the I/O device subsystem 104. For example, the I/O device related program 118 can activate an LED to allow a technician or other user to identify a specific I/O device of the I/O device subsystem 104, e.g., as part of testing, debugging, identifying a root cause of a fault, and so forth. As another example, an I/O device related program 118 can detect that a fault or other issue has occurred or may be about to occur with respect to a given I/O device 108-i. In response to determining that such a fault is about to occur (or has occurred), the I/O device related program 118 can activate an LED of the I/O device subsystem 104 to notify a user of the fault.

As a further example, an I/O device related program 118 can be used to perform handling of an input event such as a hot plug event. For example, an I/O device related program 118 can detect a hot insertion of an I/O device, and perform setup tasks for the hot inserted I/O device. The I/O device related program 118 can also detect a hot removal of an I/O device, and can modify configuration settings of the computing system 102 in response to detecting the hot removal of the I/O device.

The computing system 102 includes a connector assembly 122, and the I/O device subsystem 104 includes a connector assembly 123. Each connector assembly 122 or 123 includes a collection of connectors (a single connector or multiple connectors) to connect to electrical lines (e.g., signal lines, power lines, ground lines, etc.) of the computer bus 106-1 and the management bus 106-2.

The processor(s) 114 can be connected over a link 120-1 to the connector assembly 122 of the computing system 102. The link 120-1 allows the processor(s) 114 to communicate with the I/O device subsystem 10 over the computer bus 106-1.

In the I/O device subsystem 104, the subsystem controller 110 is connected to the connector assembly 123 to allow the subsystem controller 110 to communicate over the computer bus 106-1 and the management bus 106-2.

The computing system 102 also includes a baseboard management controller (BMC) 124 that is connected over a link 120-2 to the connector assembly 122. The link 120-2 allows the BMC 124 to communicate over the management bus 106-2. The BMC 124 is an example of a management controller of the computing system 102 to perform various designated management tasks for the computing system 102.

A “BMC” can refer to a specialized service controller that monitors the physical state of an electronic device using sensors and communicates with a remote management system (that is remote from the electronic device) through an independent “out-of-band” connection. The BMC can perform management tasks to manage components of the electronic device. Examples of management tasks that can be performed by the BMC can include any or some combination of the following: power control to perform power management of the electronic device (such as to transition the electronic device between different power consumption states in response to detected events), thermal monitoring and control of the electronic device (such as to monitor temperatures of the electronic device and to control thermal management states of the electronic device), fan control of fans in the electronic device, system health monitoring based on monitoring measurement data from various sensors of the electronic device, remote access of the electronic device (to access the electronic device over a network, for example), remote reboot of the electronic device (to trigger the electronic device to reboot using a remote command), system setup and deployment of the electronic device, system security to implement security procedures in the electronic device, and so forth.

In some examples, the BMC can provide so-called “lights-out” functionality for an electronic device. The lights out functionality may allow a user, such as a systems administrator, to perform management operations on the electronic device even if an operating system (OS) is not installed or not functional on the electronic device.

Moreover, in some examples, the BMC can run on auxiliary power provided by an auxiliary power supply (e.g., a battery); as a result, the electronic device does not have to be powered on to allow the BMC to perform the BMC's operations. The auxiliary power supply is separate from a main power supply that supplies powers to other components (e.g., a main processor, a memory, an input/output (I/O) device, etc.) of the electronic device.

In some examples, in addition to the BMC in each electronic device, an additional management controller (separate from the BMCs) can be used to interact with the BMCs to perform management of the electronic devices. In examples where the electronic devices are server computers (or other types of electronic devices) mounted in a rack, the additional management controller can be referred to as a rack management controller (RMC). A “rack” refers to a mounting structure that has supports for multiple electronic devices.

More generally, the additional management controller can be referred to as a “system management controller” to manage a collection of electronic devices that each further includes a BMC.

In accordance with some examples of the present disclosure, the BMC 124 includes I/O management logic 126, which can be implemented using a portion of the hardware processing circuit of the BMC 124 or can as machine-readable instructions executable by the BMC 124. The I/O management logic 126 performs I/O management tasks with respect to the I/O device subsystem 104, including communicating information of output events to the I/O device subsystem 104 over the management bus 106-2, and receiving information of input events over the management bus 106-2 from the I/O device subsystem 104.

The computing system 102 further includes a programmable device 130 that is connected to the BMC 124 and the processor(s) 114. A “programmable device” can refer to a device that is programmable (either by configuring hardware processing circuitry or providing machine-readable instructions such as software or firmware) to perform specified tasks. Examples of the programmable device 130 can include any or some combination of the following: a programmable logic device such as a complex programmable logic device (CPLD), a programmable gate array, a programmable integrated circuit device, and so forth.

In accordance with some examples of the present disclosure, the programmable device 130 can perform I/O expansion emulation using an I/O expansion emulator 132. The I/O expansion emulator 132 can be implemented using a portion of the hardware processing circuitry of the programmable device 130 or can be implemented as machine-readable instructions executable by the programmable device 130.

Expansion emulation emulates functionalities of I/O expanders, such as GPIO expanders. By using the programmable device 130 according to some examples of the present disclosure, a single programmable device 130 can be used instead of a corresponding large quantity of I/O expanders (and associated multiplexers) in the computing system 102 to allow for monitoring and control of features of the I/O device subsystem 104.

The expansion emulation of the I/O expansion emulator 132 provides virtual registers 134-1 to 134-N. A “virtual register” refers to a register emulated by machine-readable instructions, such as software or firmware. In some examples, each virtual register 134-i corresponds to a respective I/O device 108-i; in other words, the virtual register 134-i is used to interact with the I/O device 108-i. Different virtual registers are used to interact with respective different I/O devices. In other examples, a virtual register can be used to interact with multiple I/O devices, or alternatively, multiple virtual registers can be used to interact with a specific I/O device.

Although some examples of the present disclosure refer to a single programmable device 130, further examples of the computing system 102 can include multiple programmable devices to perform respective I/O expansion emulations, such as to interact with respective multiple I/O device subsystems.

Additionally, in accordance with some examples of the present disclosure, instead of using a proprietary protocol to communicate between the BMC 124 and the subsystem controller 110 of the I/O device subsystem 104 for the purpose of monitoring and controlling features of the I/O device subsystem 104, a standardized or open-source interface can be used.

In some examples, to support a standardized interface between the BMC 124 and the I/O device subsystem 104, the subsystem controller 110 can be implemented using a Universal Backplane Management (UBM) controller, which operates according to UBM. UBM refers to a standard for management of I/O backplanes.

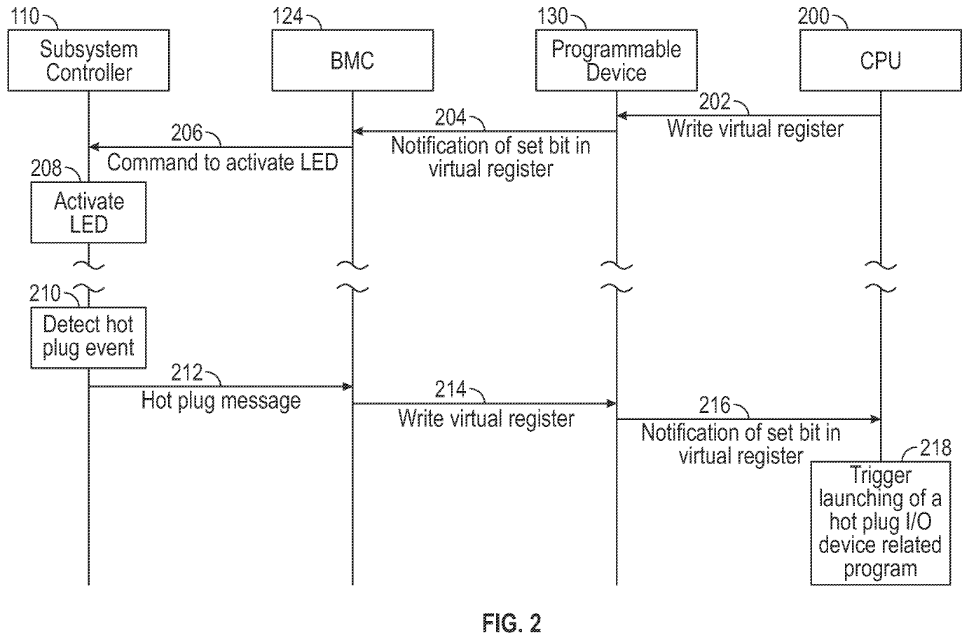

FIG. 2 is a message flow diagram of tasks performed by various components, including the subsystem controller 110, the BMC 124, the programmable device 130, and a CPU 200 (which includes the processor(s) 114 of FIG. 1).

In an example, it is assumed that a given I/O device related program 118 executing on the CPU 200 has decided to activate an LED of the I/O device subsystem 104, such as to provide an indication for a specific I/O device 108-i of the I/O device subsystem 104. The given I/O device related program 118 executing on the CPU 200 performs an I/O write (at 202) of a virtual register 134-i. Specifically, the CPU 200 can perform a write of bit X in the virtual register 134-i, which has been designated to control activation of an LED for the I/O device 108-i.

In some examples, a link 140 (FIG. 1) between the processor(s) 114 and the programmable device 130 includes an I²C bus or another type of link. The write of the virtual register 134-i is a write over the link 140. In a more specific example, the link 140 includes an SMBus.

In some examples, the link 140 can be associated with an I/O address space including multiple I/O addresses, such as I²C addresses. When accessing (writing or reading) a virtual register in the programmable device 130, the CPU 200 can specify a corresponding I/O address. For example, a given I/O address can be the address of an I/O expander emulated by the I/O expansion emulator 132. To write the virtual register 134-i, the I/O write from the CPU 200 would specify the I/O address of the emulated I/O expander that the virtual register 134-i is part of. The I/O write also provides an indication of which virtual register of the emulated I/O expander the write is to be performed on. The virtual registers 134-1 to 134-N can be part of multiple emulated I/O expanders.

The write of bit X of the virtual register 134-i sets bit X to a specific value, e.g., 1. In response to the setting of bit X of the virtual register 134-i, the programmable device 130 sends (at 204) a notification of the set bit to the BMC 124. In some examples, the notification can be in the form of an interrupt. For example, a link 142 between the programmable device 130 and the BMC 124 can support interrupts 143 of the BMC 124 by the programmable device 130 to provide the notification. In other examples, the BMC 124 can poll (e.g., periodically) the virtual registers 134-1 to 134-N of the programmable device 130 to detect any changes of the virtual registers.

In response to the notification, the BMC 124 (or more specifically, the I/O management logic 126 of the BMC 124) sends (at 206) a command to activate the LED of the I/O device 108-i to the subsystem controller 110 over the management bus 106-2. In examples where the subsystem controller 110 is a UBM controller, then the command to activate the LED can be a UBM command.

The BMC 124 may be configured with configuration information 150 (e.g., stored in a memory 152 of the BMC 124 as shown in FIG. 1) that correlates virtual registers (and bits of the virtual registers) to corresponding events. As an example, the configuration information 150 may correlate bit X of the virtual register 134-i to an activate LED event to activate the LED of the I/O device 108-i. Thus, in response to bit X of the virtual register 134-i being set, the I/O management logic 126 of the BMC 124 uses the configuration information 150 to “translate” the set bit X of the virtual register 134-i to the command to the command to activate LED.

As further examples, the configuration information 150 may correlate other bits of the virtual register 134-i to other output events, such as other output events to control other features of the I/O device 108-i. The I/O management logic 126 of the BMC 124 can “translate” any of the other bits of the virtual register 134-i being set to respective commands to control features relating to the I/O device 108-i. The “translation” is effectively a mapping, based on the configuration information 150, of a certain bit of a virtual register being set to a corresponding command to control a feature of an I/O device.

In addition, the configuration information 150 may correlate further bits of the virtual register 134-i to input events of the I/O device 108-i, such as a hot plug event or other input events.

More generally, the configuration information 150 stored by the BMC 124 may correlate different input or output events to respective bits of the virtual registers 134-1 to 134-N.

In response to the command to activate the LED, the subsystem controller 110 controls activation (at 208) of the LED of the I/O device 108-i. This LED is an example of the feature 112-i of the I/O device 108-i.

In a further example, the subsystem controller 110 can detect (at 210) a hot plug event (hot insertion or hot removal) relating to the I/O device 108-i. In response to detecting the hot plug event, the subsystem controller 110 sends (at 212) a hot plug message to the BMC 124 over the management bus 106-2. In examples where the subsystem controller 110 is a UBM controller, then the hot plug message can be a UBM message. The hot plug message identifies the I/O device 108-i involved in the hot plug event, and the type of hot plug event (hot insertion or hot removal).

In response to the hot plug message, the I/O management logic 126 of the BMC 124 can “translate” the hot plug message to a respective bit of the virtual register 134-i that the BMC 124 should set to provide an indication that a hot plug event indicated by the hot plug message has occurred. The “translation” is effectively a mapping, based on the configuration information, of a message indicating an input event to a certain bit of a virtual register.

Accordingly, the I/O management logic 126 of the BMC 124 performs an I/O write (at 214) of bit Y of the virtual register 134-i, where bit Y of the virtual register 134-i corresponds to the hot plug event indicated by the hot plug message. As an example, it is assumed that the hot plug event indicated by the hot plug message is a hot insertion of the I/O device 108-i, and bit Y of the virtual register 134-i corresponds to the hot insertion of the I/O device 108-i. The I/O write sets bit Y of the virtual register 134-i to indicate that the hot insertion of the I/O device 108-I has occurred.

As another example, the hot plug message may indicate a hot removal of the I/O device 108-i, and bit Z of the virtual register 134-i corresponds to the hot removal of the I/O device 108-i.

In response to bit Y of the virtual register 134-i being set, the programmable device 130 sends (at 216) a notification of the set bit to the CPU 200. In some examples, the link 140 between the programmable device 130 and the CPU 200 supports interrupts 141 of the CPU 200 to provide the notification (e.g., of the hot plug event). For example, an interrupt 141 can be in the form of an I²C_Alert #in examples where the link 140 is an I²C bus. In other examples, the CPU 200 may poll (e.g., periodically) the virtual registers 134-1 to 134-N to detect updates of the virtual registers.

The notification from the programmable device 130 may trigger launching (at 218) of a hot plug I/O device related program 118 to handle the hot plug event. For a hot insertion indicated by bit Y of the virtual register 134-i being set, the hot plug I/O device related program 118 can perform actions to set up the hot inserted I/O device 108-i. As another example, if the hot plug event is a hot removal of the I/O device 108-i, the hot plug I/O device related program 118 can perform actions to update configuration information to indicate that the I/O device 108-i is no longer present.

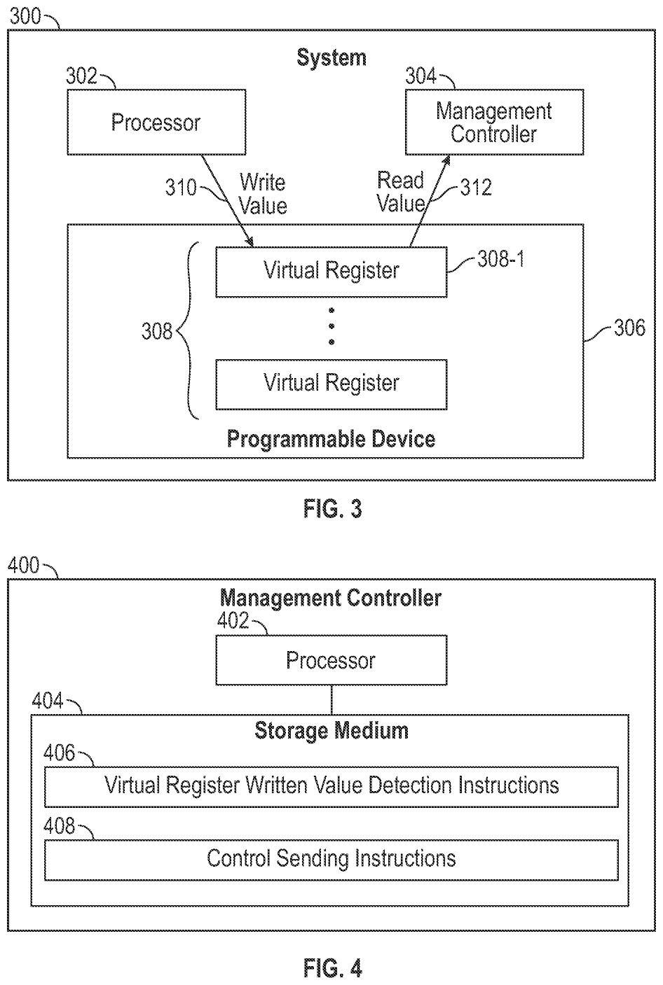

FIG. 3 is a block diagram of a system 300. As an example, the computing system 102 of FIG. 1 is an example of the system 300.

The system 300 includes a processor 302 (or multiple processors). The system 300 further includes a management controller 304, such as the BMC 124 of FIG. 1.

The system 300 further includes a programmable device 306 to provide I/O expansion emulation to support communication with a plurality of I/O devices of a subsystem (e.g., the I/O device subsystem 104 of FIG. 1) coupled to the system 300. The programmable device 306 provides a plurality of virtual registers 308 as part of the I/O expansion emulation. The virtual registers 308 are associated with respective I/O devices of the subsystem.

The processor 302 is to write (310) a value to a first virtual register 308-1 of the plurality of virtual registers 308 to trigger an output event relating to a first I/O device at the subsystem.

The management controller 304 is to read (312) the first virtual register 308-1 and, in response to the value written to the first virtual register 308-1, interact with the subsystem to issue the output event relating to the first I/O device at the subsystem.

In some examples, the first virtual register 308-1 includes a plurality of register portions (e.g., bits), and a first register portion of the plurality of register portions is settable to different values to control whether or not the output event is triggered (e.g., whether or not a visual indicator for the first I/O device is to be activated or deactivated). The value is written to the first virtual register 308-1 by setting the value in the first register portion.

In some examples, the management controller 304 is to interact with a Universal Backplane Management (UBM) controller in the subsystem to issue the output event relating to the first I/O device at the subsystem.

In some examples, the system 300 includes a connector assembly to connect over a computer bus to the subsystem, where the processor 302 is to communicate with the I/O devices through the connector assembly and over the computer bus.

In some examples, the management controller 304 is to detect a further event (e.g., a hot plug event) relating to the first I/O device at the subsystem, and write a further value to the first virtual register 308-1. The processor 302 is to read the further value written to the first virtual register 308-1, and in response to the further value, detect that the further event relating to the first I/O device has occurred at the subsystem.

In some examples, the management controller 304 includes a memory to store configuration information (e.g., 150 in FIG. 1) that correlates register portions of the virtual registers 308 to respective different input events and output events. The management controller 304 is to access the configuration information in response to detecting that the value has been written to the first virtual register, and send, based on the configuration information, a command to the subsystem to trigger the output event.

FIG. 4 is a block diagram of a management controller 400, such as the BMC 124 of FIG. 1. The management controller 400 includes a processor 402 (which is separate from the processor(s) 114 of the computing system 102, for example).

The management controller 400 includes a storage medium 404 storing machine-readable instructions executable on the processor 402 to perform various tasks. Machine-readable instructions executable on a hardware processor can refer to the instructions executable on a single hardware processor or the instructions executable on multiple hardware processors.

The machine-readable instructions include virtual register written value detection instructions 406 to detect a value written to a first portion of a first virtual register of a plurality of virtual registers that are part of I/O expansion emulation provided by a programmable device. The plurality of virtual registers are associated with respective I/O devices of a plurality of I/O devices of an I/O device subsystem. The value written to the first portion of the first virtual register is by a CPU separate from the management controller 400 for control of a feature relating to a first I/O device of the I/O device subsystem, where the CPU is to communicate with the plurality of I/O devices over a computer bus.

The machine-readable instructions include control sending instructions 408 to, in response to the detecting of the value written to the first portion of the first virtual register, send, from the management controller 400 over a management bus separate from the computer bus, control information to a subsystem controller of the I/O device subsystem, to cause the I/O device subsystem to control the feature relating to the first I/O device of the I/O device subsystem.

In some examples, the machine-readable instructions detect an occurrence of an input event relating to a second I/O device of the plurality of I/O devices, and in response to the detecting of the occurrence of the input event, write a value to a second portion of the first virtual register, to trigger handling of the event by the CPU.

In some examples, an interface between the management controller and the I/O device subsystem relating to the control of the feature relating to the first I/O device is a standardized interface or an open-source interface. For example, the standardized interface can be according to UBM. An open-source interface can conform to any interface defined by open-source specifications.

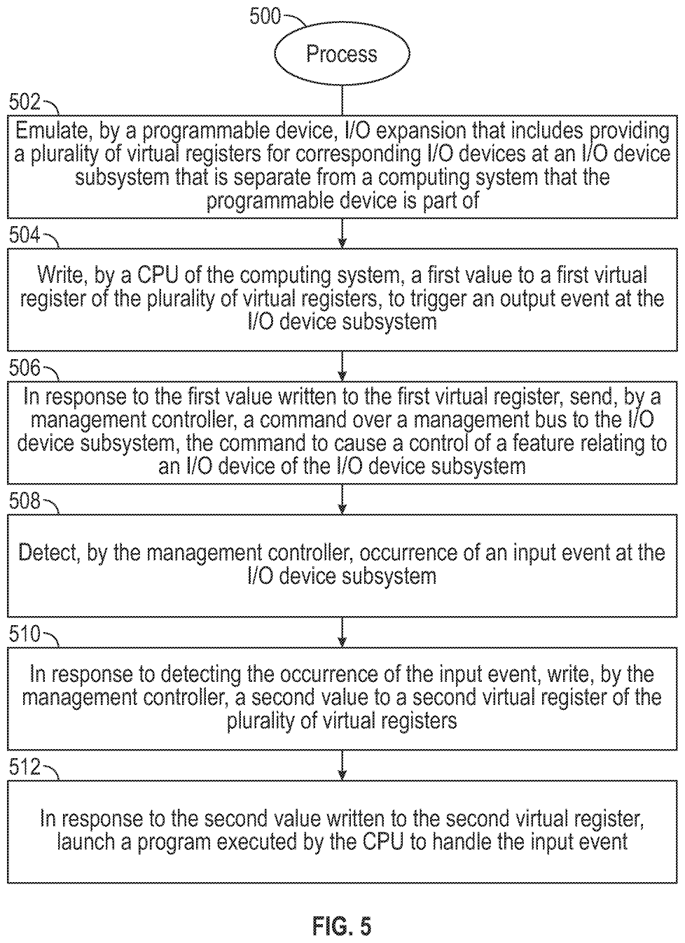

FIG. 5 is a flow diagram of a process 500, which can be performed by the computing system 102 or the system 300, for example. The process 500 includes emulating (at 502), by a programmable device, I/O expansion that includes providing a plurality of virtual registers for corresponding I/O devices at an I/O device subsystem that is separate from a computing system that the programmable device is part of.

The process 500 includes writing (at 504), by a CPU of the computing system, a first value to a first virtual register of the plurality of virtual registers, to trigger an output event at the I/O device subsystem. The first value can be written to a given register portion (e.g., a given bit) of the first virtual register, such as by a program executed by the CPU.

The process 500 includes, in response to the first value written to the first virtual register, sending (at 506), by a management controller, a command over a management bus to the I/O device subsystem, the command to cause a control of a feature relating to an I/O device of the I/O device subsystem.

The process 500 includes detecting (at 508), by the management controller, occurrence of an input event at the I/O device subsystem. The detection of the occurrence of the input event can be based on a message sent by the I/O device subsystem over the management bus to the management controller.

The process 500 includes, in response to detecting the occurrence of the input event, writing (at 510), by the management controller, a second value to a second virtual register of the plurality of virtual registers.

The process 500 includes, in response to the second value written to the second virtual register, launching (at 512) a program executed by the CPU to handle the input event.

In the present disclosure, use of the term “a,” “an,” or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

A storage medium (e.g., 116 in FIG. 1, 404 in FIG. 4) can include any or some combination of the following: a semiconductor memory device such as a DRAM or SRAM, an erasable and programmable read-only memory (EPROM), an electrically erasable and programmable read-only memory (EEPROM) and flash memory; a magnetic disk such as a fixed, floppy and removable disk; another magnetic medium including tape; an optical medium such as a compact disk (CD) or a digital video disk (DVD); or another type of storage device. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A system comprising:
a processor;
a management controller; and
a programmable device to provide input/output (I/O) expansion emulation to support communication with a plurality of I/O devices of a subsystem coupled to the system, wherein the programmable device provides a plurality of virtual registers as part of the I/O expansion emulation, the virtual registers associated with respective I/O devices of the plurality of I/O devices,
wherein the processor is to write a value to a first virtual register of the plurality of virtual registers to trigger an output event relating to a first I/O device of the plurality of I/O devices at the subsystem,
wherein the management controller is to read the first virtual register and, in response to the value written to the first virtual register, interact with the subsystem to issue the output event relating to the first I/O device at the subsystem.

2. The system of claim 1, wherein the programmable device is to interrupt the management controller in response to the writing of the value to the first virtual register, or the management controller is to poll the first virtual register to detect the value written to the first virtual register.

3. The system of claim 1, wherein the first virtual register comprises a plurality of register portions, and a first register portion of the plurality of register portions is settable to different values to control whether or not the output event is triggered, and wherein the writing of the value to the first virtual register comprises setting the value in the first register portion.

4. The system of claim 1, wherein the management controller is to interact with a Universal Backplane Management (UBM) controller in the subsystem to issue the output event relating to the first I/O device at the subsystem.

5. The system of claim 1, further comprising:
a non-transitory storage medium storing machine-readable instructions executable on the processor to write the value to the first virtual register.

6. The system of claim 5, wherein the machine-readable instructions are executable on the processor to write the value to the first virtual register to cause activation of a visual indicator for the first I/O device at the subsystem.

7. The system of claim 1, further comprising a connector assembly to connect over a computer bus to the subsystem, wherein the processor is to communicate with the I/O devices through the connector assembly and over the computer bus.

8. The system of claim 7, wherein the computer bus comprises a Peripheral Component Interconnect Express (PCIe) bus, and wherein the management controller is to communicate with the subsystem over a management bus that is separate from the PCIe bus.

9. The system of claim 1, wherein the management controller is to detect a further event relating to the first I/O device at the subsystem, and write a further value to the first virtual register, and
wherein the programmable device is to interrupt the processor in response to the writing of the further value to the first virtual register, or the processor is to poll the first virtual register to detect the further value written to the first virtual register, and
in response to the further value, the processor is to detect that the further event relating to the first I/O device has occurred at the subsystem.

10. The system of claim 9, wherein the further event comprises a hot plug event relating to a hot insertion or a hot removal of the first I/O device.

11. The system of claim 9, wherein the first virtual register comprises a plurality of register portions, and a first register portion of the plurality of register portions is settable to different values to control whether or not the output event is triggered, and wherein the writing of the value to the first virtual register comprises setting the value in the first register portion, and
wherein the management controller is to indicate occurrence of the further event by writing the further value to a second register portion of the plurality of register portions of the first virtual register.

12. The system of claim 9, wherein the processor is to launch machine-readable instructions to handle the further event at the subsystem.

13. The system of claim 1, wherein the management controller comprises a memory to store configuration information that correlates register portions of the virtual registers to respective different input events and output events, and the management controller is to:
access the configuration information in response to detecting that the value has been written to the first virtual register, and
send, based on the configuration information, a command to the subsystem to trigger the output event.

14. A management controller comprising:
a processor; and
a non-transitory storage medium storing instructions executable on the processor to:
detect a value written to a first portion of a first virtual register of a plurality of virtual registers that are part of input/output (I/O) expansion emulation provided by a programmable device, wherein the plurality of virtual registers are associated with respective I/O devices of a plurality of I/O devices of an I/O device subsystem, and wherein the value written to the first portion of the first virtual register is by a central processing unit (CPU) separate from the management controller for control of a feature relating to a first I/O device of the I/O device subsystem, wherein the CPU is to communicate with the plurality of I/O devices over a computer bus; and
in response to the detecting of the value written to the first portion of the first virtual register, send, from the management controller over a management bus separate from the computer bus, control information to a subsystem controller of the I/O device subsystem, to cause the I/O device subsystem to control the feature relating to the first I/O device of the I/O device subsystem.

15. The management controller of claim 14, wherein the instructions are executable on the processor to:
detect an occurrence of an input event relating to a second I/O device of the plurality of I/O devices; and
in response to the detecting of the occurrence of the input event, write a value to a second portion of the first virtual register, to trigger handling of the input event by the CPU separate from the management controller.

16. The management controller of claim 15, wherein the input event relating to the first I/O device comprises a hot plug event relating to hot plugging of the first I/O device.

17. The management controller of claim 15, wherein the detecting of the occurrence of the input event relating to the second I/O device is based on a message indicating the input event received at the management controller from the I/O device subsystem.

18. The management controller of claim 14, wherein an interface between the management controller and the I/O device subsystem relating to the control of the feature relating to the first I/O device is a standardized interface or an open-source interface.

19. A method comprising:
emulating, by a programmable device, input/output (I/O) expansion that comprises providing a plurality of virtual registers for corresponding I/O devices at an I/O device subsystem that is separate from a computing system that the programmable device is part of;
writing, by a central processing unit (CPU) of the computing system, a first value to a first virtual register of the plurality of virtual registers, to trigger an output event at the I/O device subsystem;
in response to the first value written to the first virtual register, sending, by a management controller, a command over a management bus to the I/O device subsystem, the command to cause a control of a feature relating to an I/O device of the I/O device subsystem;
detecting, by the management controller, occurrence of an input event at the I/O device subsystem;
in response to detecting the occurrence of the input event, writing, by the management controller, a second value to a second virtual register of the plurality of virtual registers; and
in response to the second value written to the second virtual register, launch a program executed by the CPU to handle the input event.

20. The method of claim 19, wherein the input event comprises a hot plug event, and the program executed by the CPU handles the hot plug event that comprises hot plugging of an I/O device at the I/O device subsystem.
